(19) United States
(12) Patent Application Publication
(10) Pub. No.: US 2003/0123860 A1
(43) Pub. Date: Jul. 3, 2003

(54) DVD reproduction method and device especially for use in a motor vehicle

(76) Inventors: Michael Huebner, Garbsen (DE); Matthias Scholz, Hildesheim (DE)

Correspondence Address: KENYON & KENYON, ONE BROADWAY, NEW YORK, NY, 10004, US

(21) Appl. No.: 10/204,947

(22) PCT Filed: Dec. 5, 2001
(86) PCT No.: PCT/DE01/04566

(51) Int. Cl. H04N 5/781

(52) U.S. Cl. 386/124; 386/125; 386/126

(57) ABSTRACT

The present invention creates a DVD playback device and a corresponding playback method. The device includes a DVD data supply device (20; 30; 40) for supplying DVD data, the DVD data including at least first video data and second video data; a first video data decoding device (60) for receiving the DVD data and for decoding the first video data included therein; a second video data decoding device (70) for receiving the DVD data and for decoding the second video data included therein; a video data display device (80; 90; 100) for receiving and visually displaying the first and second decoded video data (V; S); a background image data supply device (150) for supplying background image data; and a controllable switchover device (S1; S1, S2) for interrupting the receiving of the DVD data by the first video data decoding device (60) and for connecting the supplied background image data to the first video data decoding device (60) or to the video data display device (80; 90; 100).

### BACKGROUND INFORMATION

The present invention relates to a DVD playback device, especially for use in a motor vehicle, having a DVD data supply device to supply DVD data, the DVD data including at least first video data and second video data; a first video data decoding device for receiving the DVD data and for decoding the first video data contained in it; a second video data decoding device for receiving the DVD data and for decoding the second video data contained in it; and a video data display device for receiving and visually displaying the first and second decoded video data. The present invention also relates to a corresponding DVD playback method.

Even though they are applicable to any DVD playback devices, the present invention as well as the underlying problem are explained with respect to a DVD playback device in an automobile.

In recent times the DVD (digital versatile disk) medium has become generally established in the market, and is shipped for a number of products. At this time, DVD is particularly entering the motor vehicle field, which leads to the posing of interesting new problems.

Because of the increased memory capacity compared to the compact disk (CD), the digital versatile disk (DVD) is ideally suited to motor vehicle applications. In this connection, the use of the DVD is not limited only to storing data, such as for motor vehicle navigation, but is also used especially for playing DVD video media, that is, for playback of moving images and sound for entertainment purposes.

FIG. 3 is a block diagram of a known DVD playback device in a motor vehicle.

In FIG. 3 reference numeral 1 generally denotes a DVD playback device or a DVD player. DVD playback device 1 includes a DVD drive 20 for reading the DVD, a decoding device 30 for undoing the coding, and a temporary storage device 40 for the temporary storage of the DVD data. Components 20, 30, 40 are also denoted as DVD data supply devices below.

The output of temporary storage device 40 is connected to a node K1. From node K1, a first signal path a goes to a video decoder 60, for decoding moving video data and outputting decoded moving video data V. Decoder 60 may be such as an MPEG decoder. A second signal path b goes to an inset decoder 70 for decoding of an inset or subpicture data stream, and for output of a decoded inset data stream S. A third signal path c goes to an audio decoder 50 for decoding of audio data included in the DVD data stream.

Audio decoder 50 is connected to a loudspeaker 110 for the output of audio data. The decoded moving video data V and the decoded inset data S are passed on to an image memory 80, from which they are delivered to a video controller 90. Video controller 90 is used for integrating the moving video data V and inset data S, as well as for screen generation and generation of screen display on screen 100. Image memory 90 is used for temporary storage of image data during decoding.

Finally, known DVD playback device 1 includes a control device 10 for disk navigation, drive control and for general sequencing control, which is expressed by arrows that are supposed to indicate various control signals, here not specified more closely, for the individual components of DVD playback device 1.

Thus, a DVD usually includes three different kinds of data streams, namely video data streams having moving video images, audio data streams and inset data streams, the inset data streams in general being used for subtitles and for user guidance (user interface). In this context, the user interface may be designed individually for each individual DVD by each respective manufacturer. While the subtitle of a DVD may always be suppressed, video, audio and user interfaces are usually coupled to one another by specification of the manufacturer.

Sound playback during automobile travel is commonly regarded as being no cause for concern. The same applies to the playback of subpicture information texts or navigation images. On the other hand, the playback of moving images during automobile travel must be regarded as critical, since the driver of the motor vehicle may be distracted by the movement, this being so even if the image playback is used only for the entertainment of the passengers. That is why the playback of moving images in motor vehicles is prohibited by law in some countries, for instance in various US states.

### SUMMARY OF THE INVENTION

As compared to the known attempts at solutions, the device according to the present invention having the features of claim 1, and the corresponding method according to claim 17 have the advantage that the viewer, especially the driver of the motor vehicle, is not distracted by a DVD by predetermined images, in particular moving images.

However, it is further possible, in this context, to reproduce certain other predetermined images and possibly audio data. Preferably, the predetermined other images are inset or subpicture data. In this connection, it is possible to control the DVD playback device using the user interface stored in the DVD, since a representation of these subpicture data on the screen is made possible.

A further advantage is that any desired background image, which may expediently be selected by the driver, may replace the suppressed moving video images.

The idea on which the present invention is based is that it provides a background image data supply device for supplying background image data, and a controllable switching device for interrupting the receiving of the DVD data by the first video data device and for connecting the supplied background image data to the first video data decoding device or to the video data display device. For example, the representation of the moving video data may be suppressed during travel, so that no distraction of the motor vehicle's driver can occur. However, the audio data contained in the DVD may be played. Also, the screen does not have to be switched off completely, since the inset data may continue to be displayed for user guidance.

Delineated in the dependent claims are advantageous embodiments of the particular subject matter of the present invention, as well as improvements thereto.

According to one preferred refinement, the DVD data supply device has a DVD drive, a decoding device and a temporary storage device.

According to another preferred refinement, the video data display device has an image memory, a video controller and a screen.

In still another preferred refinement, the controllable switching device has a first controllable switch provided between a first node and the input to the first video data decoding device, the first node also being connected to the DVD data supply device and the second video data decoding device.

According to yet another preferred development, the controllable switching device has a second controllable switch provided between the output of the first video data decoding device and the video data display device.

In a further preferred refinement, the first and/or the second controllable switch may be connected to a second node which is connected to the background image data supply device.

According to one additional preferred refinement, the DVD data include audio data which may be conducted to a loudspeaker via an audio data decoding device.

And according to a further preferred development, the background image data are fixed image data.

In a further preferred refinement, a contrast modification device is provided, which modifies the contrast for displaying the first and second decoded video data. Thereby it is possible to have sufficient contrast existing, even with an unfavorable selection of the background image, with respect to the faded-in second video data to be represented, e.g. subpicture data.

In a still further preferred refinement, the contrast modification device is post-connected to the second video data decoding device and modifies the second video data in the edge region to the first video data.

According to yet another preferred refinement, the modification in the second video data is that they may be set to the inverted value of the most significant bit of the digital value of the first video data in the edge region.

According to yet another preferred refinement, the modification in the second video data is that, in the case of predefined background image data, the digital value of the first video data in the edge region is set to a fixed, predefined chromaticity.

According to still another preferred development, a control device is provided for controlling the controllable switching device which does the switching in response to an externally influencing variable. The decision on activating or deactivating the video data stream suppression may be made in the control software, and may therefore be made dependent on any number of external or even internal influencing variables.

Another preferred refinement provides that the DVD playback device is used in a motor vehicle, and the external influencing variable is a motor vehicle parameter.

Yet another preferred refinement provides that the motor vehicle parameter is selected from the following group: Engine start, engine stop, travel motion, transmission setting, parking brake setting.

In one further preferred refinement the first video data are moving video data, and the second video data are non-moving video data.

### BRIEF DESCRIPTION OF THE DRAWINGS

Exemplary embodiments of the present invention are represented in the drawings and explained in detail in the following description.

The figures show:

FIG. 1 a block diagram of a DVD playback device in a motor vehicle, according to one specific embodiment of the present invention.

FIG. 2 a display representation on a display unit of a DVD playback device in a motor vehicle, according to the specific embodiment of the present invention.

FIG. 3 a block diagram of a known DVD playback device in a motor vehicle.

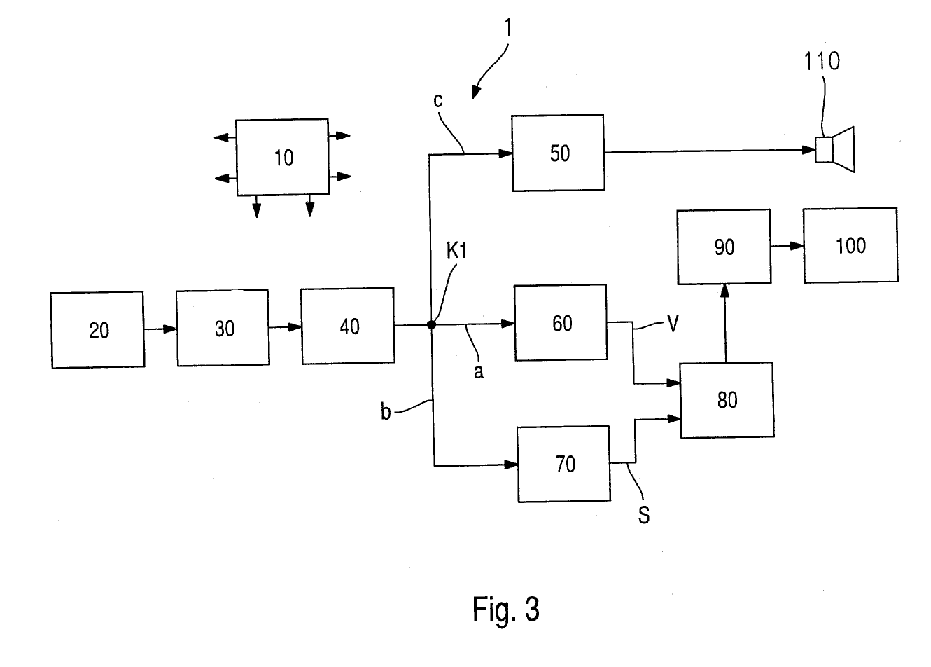

### DESCRIPTION OF THE EXEMPLARY-EMBODIMENTS

In the figures, the same reference numerals denote the same or functionally the same component parts.

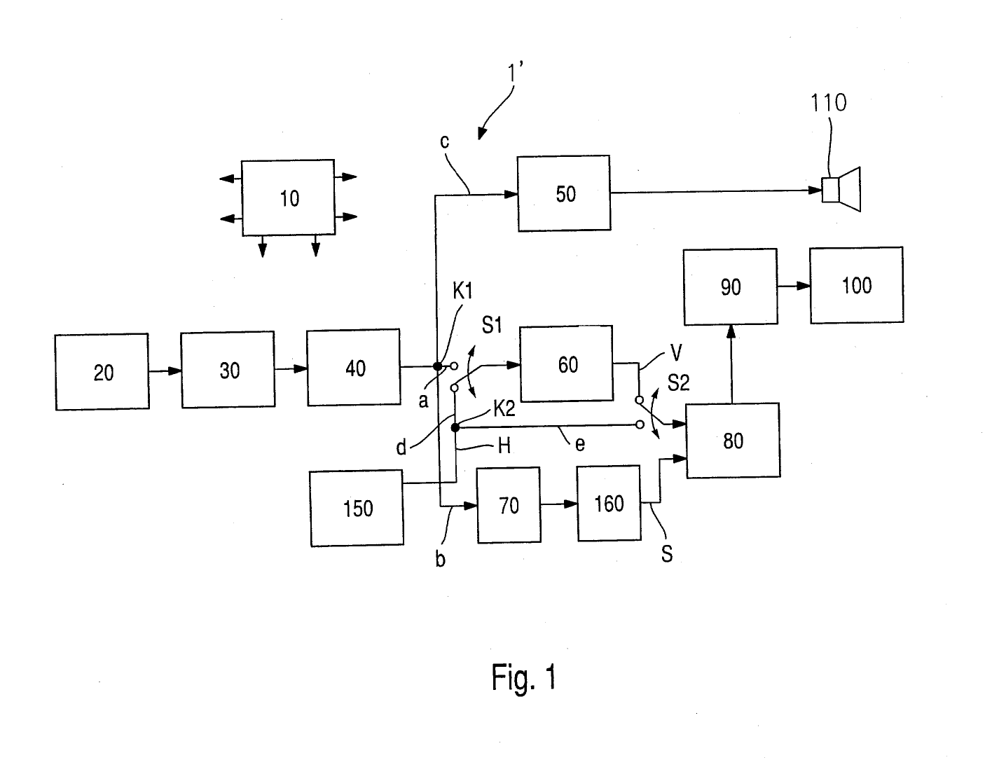

FIG. 1 shows a block diagram of a DVD playback device 1 in a motor vehicle, according to one specific embodiment of the present invention.

In FIG. 1, in addition to the components already introduced, S1 denotes a first controllable switch and S2 denotes a second controllable switch. In this example, control device 10 assumes the control function according to certain motor vehicle parameters.

Reference numeral 150 denotes a background image data supply device for supplying background image data H, which is connected to a node K2. From node K2, a signal path d goes to a switch position of switch S1, whose other switch position leads to signal path a. Another signal path e goes from node K2 to a switch position of switch S2, whose other switch position is connected to the output of video decoder 60. Finally, reference numeral 160 in FIG. 1 denotes a contrast modification device.

In the exemplary embodiment shown in FIG. 1, the DVD data stream, which is conducted to video decoder 60 on signal path a, may be interrupted by switch S1 controlled by control device 10 and may be switched to background data H which come from background image data supply device 150 via node K2.

Thus, instead of the moving video data, a previously stored fixed image, which, for example, may hold a text concerning the reason for the video suppression, may be conducted by the DVD to video decoder 60 or directly written into image memory 80. The latter depends on the setting of second switch S2. If switch S2 is connected to the output of video decoder 60, the background image data are conducted via video decoder 60, whereas when switch S2 is connected to. signal path e, background image data H are written directly into image memory 80. Because of the last measure, flexibility is increased with respect to background image data H to be supplied.

By the appropriate programming of control device 10, activation of the suppression of the moving video data, that is, the switchover of switch S1 or S2, may be made dependent upon various motor vehicle parameters, such as the setting of the ignition lock, the driving speed or even legal instructions in the country of delivery.

For example, a possible strategy would be activation of the suppression when the vehicle first moves after the engine is started, for instance, upon reaching a speed of 5 km/h or 10 km/h, and deactivation of the suppression when the engine is switched off. A further possibility would be deactivation of the suppression upon exiting the parking place, detected, for instance, by leaving the P position in the case of an automatic transmission or by releasing the parking brakes in the case of a standard transmission, and deactivation upon arriving at a parking space, such as by choosing the automatic transmission setting P, or by setting the parking brakes. In addition to that, any desired combination of the influencing variables named above, as well as linkage with additional influencing variables, or as a function of other influencing variables, is conceivable.

Under certain circumstances, the specific embodiment described in reference to FIG. 1 can have the result that the inset data, which are further conducted to image memory 80 via signal path b and via inset decoder 70, demonstrate poor contrast to the background image data.

In particular, a certain writing on a transparent inset background is frequently selected for the inset data, whereby the respective characters are faded directly into the running video. Thus, in the case of an unfavorable selection of the background image, the contrast between faded-in writing and background image may become too slight, as in the case of dark writing on a dark background or vice versa.

In order to avoid this, the signal path for the inset data includes contrast modification device 160.

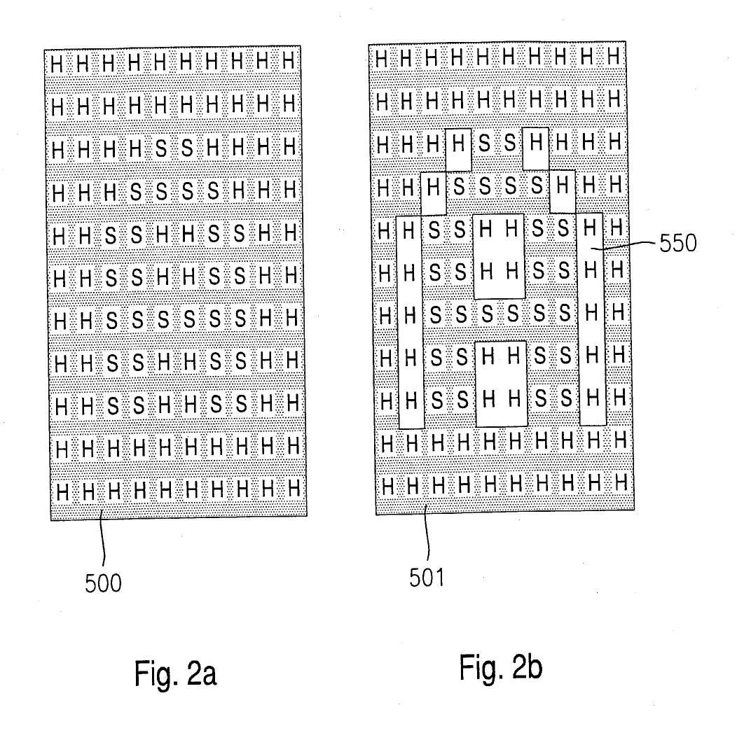

FIG. 2 shows a display representation on a display unit of a DVD playback device in a motor vehicle, according to the specific embodiment of the present invention.

In FIG. 2a, 500 denotes a video screen display without contrast modification on video screen 100. On the video screen display, H denotes background image data and S denotes inset data. Because of the particular selection of the background image, in FIG. 2a the inset data may not be identifiable at all, or only with great difficulty.

In FIG. 2b, 501 denotes a video screen display on video screen 100 having a contrast modification performed by contrast modification device 160. In particular, in this specific embodiment, a contrast strip, shown as white in FIG. 2b, is created in a side edge area 550 from the inset data in background image data H.

For this purpose, in inset decoder 70 the transitions transparent/non-transparent of the characters of the inset data have been detected and been communicated to contrast modification device 160.

Thereupon contrast modification device 160 sets a strip, one or more pixels wide, of the background image data in image memory 80 in edge area 550 of the characters of the inset data to a modified image data value. A simple and universal kind of modification is, for example, inverting the most significant bit (MSE) of the digital chromaticity of the text color. It is even simpler to specify a fixed chromaticity for the strip to be modified. To do this, however, one has to know the respective background color.

Although, according to FIG. 2b, only the lateral edge areas are inverted, the upper and lower edge areas of the inset data can, of course, also be inverted. It is also possible not to modify the background image data but rather the inset information image data.

What is claimed is:

1. DVD playback method and device, especially for use in a motor vehicle, having:
a DVD data supply device (20; 30; 40) for supplying DVD data, the DVD data including at least first video data and second video data;
a first video data decoding device (60) for receiving the DVD data and for decoding the first video data contained therein;
a second video data decoding device (70) for receiving the DVD data and for decoding the second video data contained therein; and
a video data display device (80; 90; 100) for receiving and visually displaying the first and second decoded video data,
characterized by a background image data supply device (150) for supplying background image data (H); and
a controllable switch-over device (S1; S1, S2) for interrupting the receiving of the DVD data by a first video data decoding device (60) and for connecting the supplied background image data to the first video data decoding device (60) or the video data display device (80; 90; 100).

2. The DVD playback device as recited in claim 1, wherein the DVD data supply device (20; 30; 40) has a DVD drive (20), a decoding device (30) and a temporary storage device (40).

3. The DVD playback device as recited in claim 1 or 2, wherein the video data display device (80; 90; 100) has an image memory (80), a video controller (90) and a video screen (100).

4. The DVD playback device as recited in claim 1, 2, or 3, wherein the controllable switchover device (S1; S1, S2) has a first controllable switch (S1) provided between a first node (K1) and the input to the first video data decoding device (60), the first node (K1) also being connected to the DVD data supply device (20; 30; 40) and the second video data decoding device (70).

5. The DVD playback device as recited in claim 4, wherein the controllable switchover device (S1; S1, S2) has a second controllable switch (S2), provided between the output of the first video data decoding device (60) and the video data display device (80; 90; 100).

6. The DVD playback device as recited in claim 4 or 5, wherein the first and/or second controllable switch (S1, S2) may be connected to a second node (K2), which is connected to the background image data supply device (150).

7. The DVD playback device as recited in one of the preceding claims, wherein the DVD data include audio data which may be conducted to a loudspeaker (110) via an audio data decoding device (50).

8. The DVD playback device as recited in one of the preceding claims, wherein the background image data are fixed image data.

9. The DVD playback device as recited in one of the preceding claims, wherein a contrast modification device (160) is provided, which modifies the contrast for displaying the first and second decoded video data.

10. The DVD playback device as recited in claim 9, wherein the contrast modification device (160) is post-connected to the second video data decoding device (70) and modifies the second video data in the edge region to the first video data.

11. The DVD playback device as recited in claim 10, wherein the modification in the second video data is that they may be set to the inverted value of the most significant bit of the digital value of the first video data in the edge region.

12. The DVD playback device as recited in claim 10, wherein the modification in the second video data is that, in the case of predefined background image data, the digital value of the first video data in the edge region is set to a fixed, predefined chromaticity.

13. The DVD playback device as recited in one of the preceding claims, wherein a control device (10) is provided for controlling the controllable switchover device (S1; S1, S2), which acts to make the switchover in response to an external influencing variable.

14. The DVD playback device as recited in claim 13, wherein it is used in a motor vehicle and the external influencing variable is a motor vehicle parameter.

15. The DVD playback device as recited in claim 14, wherein the motor vehicle parameter is selected from the following group:
engine start, engine stop, travel motion, transmission setting, parking brake setting.

16. The DVD playback device as recited in one of the preceding claims, wherein the first video data are moving video data and the second video data are non-moving video data.

17. DVD Playback method, especially for use in a motor vehicle, having the following steps:
supplying DVD data, the DVD data including at least first video data and second video data;
decoding the first video data included in the DVD data using a first video data decoding device (60);
decoding the second video data included in the DVD data using a second video data decoding device (70); and
visual display of the first and second decoded video data;
characterized by the steps:
supplying background image data (H);
interrupting the receiving of the DVD data by the first video data decoding device (60);
connecting the supplied background image data to the first video data decoding device (60) or to the video data display device (80; 90; 100); and
visually displaying the second decoded video data and the background image data.

18. The DVD playback method as recited in claim 17, wherein the DVD. data. include audio. data which .may be conducted to a loudspeaker (110) via an audio data decoding device (50).

19. The DVD playback method as recited in claim 17 or 18, wherein the background image data are fixed image data.

20. The DVD playback method as recited in claim 17, 18 or 19, wherein the contrast for displaying the first and second decoded video data is modified.

21. The DVD playback method as recited in claim 20, wherein the second video data are modified to the first video data in the edge area.

22. The DVD playback method as recited in claim 21, wherein the modification in the second video data is that they may be set to the inverted value of the most significant bit of the digital value of the first video data in the edge region.

23. The DVD playback method as recited in claim 21, wherein the modification in the second video data is that, in the case of predefined background image data, the digital value of the first video data in the edge area is set to a fixed, predefined chromaticity in the edge area.

24. The playback method as recited in one of the preceding claims 17 through 23, wherein the switchover is carried out in response to an external influencing variable.

25. The DVD playback method as recited in claim 24, wherein it is used in a motor vehicle and the external influencing variable is a motor vehicle parameter.

26. The DVD playback method as recited in claim 25, wherein the motor vehicle parameter is selected from the following group:
engine start, engine stop, travel motion, transmission setting, parking brake setting.

27. The playback device as recited in one of the preceding claims 17 through 26, wherein the first video data are moving video data and the second video data are non-moving video data.
